(19) United States
(12) Patent Application Publication
(10) Pub. No.: US 2009/0072092 A1
(43) Pub. Date: Mar. 19, 2009

(54) Bimodal kite system

(75) Inventors: Saul Griffith, San Francisco, CA (US); Peter Lynn, Alameda, CA (US); Don Montague, Maui, HI (US); Corwin Hardham, San Francisco, CA (US)

Correspondence Address: VAN PELT, YI & JAMES LLP, 10050 N. FOOTHILL BLVD #200, CUPERTINO, CA, 95014, US

(73) Assignee: Makani Power, Inc.

(21) Appl. No.: 11/901,262

(22) Filed: Sep. 13, 2007

(51) Int. Cl. B64C 31/06

(52) U.S. Cl. 244/155 A

(57) ABSTRACT

A kite is disclosed. The kite comprises a first control element coupled to the kite in a first tether-force configuration, wherein the first control element is used to maintain controlled flight of the kite in the first tether-force configuration during a power generating phase. The kite further comprises a second control element coupled to the kite in a second tether-force configuration, wherein the second control element is used to maintain controlled flight of the kite in the second tether-force configuration during a recovery phase, and wherein during the recovery phase a tether force associated with the second tether-force configuration is reduced as compared to the tether force associated with the first tether-force configuration during the power generating phase

### BACKGROUND OF THE INVENTION

A kite can be used to generate power from the wind. Power can be generated when a kite tether line is pulled out by the wind on the kite. The kite tether line is then pulled in. The process can then be repeated. However, one problem in this method of generating power is that net power is generated only in the event that more power is generated as the kite is let out in the power generating phase, than is used to pull in the kite in the recovery phase. Also, in reducing the power required to pull in the kite, the kite must still be flown in a controllable manner so that it can be maintained appropriately aloft. It would be beneficial to be able to generate power using a kite without loss of control of the kite.

### BRIEF DESCRIPTION OF THE DRAWINGS

Various embodiments of the invention are disclosed in the following detailed description and the accompanying drawings.

FIG. 1 is a block diagram illustrating an embodiment of a bimodal kite system.

FIG. 2A is a block diagram illustrating an embodiment of a bimodal kite.

FIG. 2B is a block diagram illustrating an embodiment of a bimodal kite.

FIG. 3A is a block diagram illustrating an embodiment of a bimodal kite.

FIG. 3B is a block diagram illustrating an embodiment of a bimodal kite.

FIG. 4A is a block diagram illustrating an embodiment of a bimodal kite.

FIG. 4B is a block diagram illustrating an embodiment of a bimodal kite.

FIG. 5A is a block diagram illustrating an embodiment of a bimodal kite.

FIG. 5B is a block diagram illustrating an embodiment of a bimodal kite.

FIG. 6 is a flow diagram illustrating an embodiment of a process for controlling a kite.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A bimodal kite system is disclosed. A kite system can be controlled in a first and second tether-force configuration. A kite is let out during a power generating phase and pulled back in during recovery phase. During the recovery phase a tether force associated with the second tether-force configuration is reduced as compared to the tether force associated with the first tether-force configuration during the power generating phase.

A control system, which includes a first control element, maintains controlled flight of the kite in the first tether-force configuration. Controlled flight comprises flight of the kite such that the kite can be steered to enable positioning of the kite. The control system, which includes a second control element, maintains controlled flight for the kite in the second tethered-force configuration. In various embodiments, the control system includes control elements that enable controlling the kite in two configurations that are separate for the two configurations, that share elements between the two configurations, are combined for the two configurations, are the same for the two configurations, or any other appropriate allocation of the control elements. The configuration of the kite can be changed between the first tether-force configuration and the second tethered-force configuration. In various embodiments, the control system enables changing between the first tether-force configuration and the second tether-force configuration.

In some embodiments, a kite is used to pull a power extractor around a circular track. The kite is utilizes a first and second tether-force configuration to improve power generation efficiency by reducing the amount of energy spent in pulling the power extractor for the portion of the circular track when the power extractor is moving up wind. Although the remaining disclosure discusses the first and second tether-force configuration as used in the situation where a kite is let out (e.g., in a power generating phase) and later recovered (e.g., in a recovery phase), the first and second tether-force configurations are also applicable to other generation configurations such as pulling a power extractor around a circular track, pulling a generator on a linear track, or any other configuration for power extraction where two tether-force configurations increase power generation efficiency.

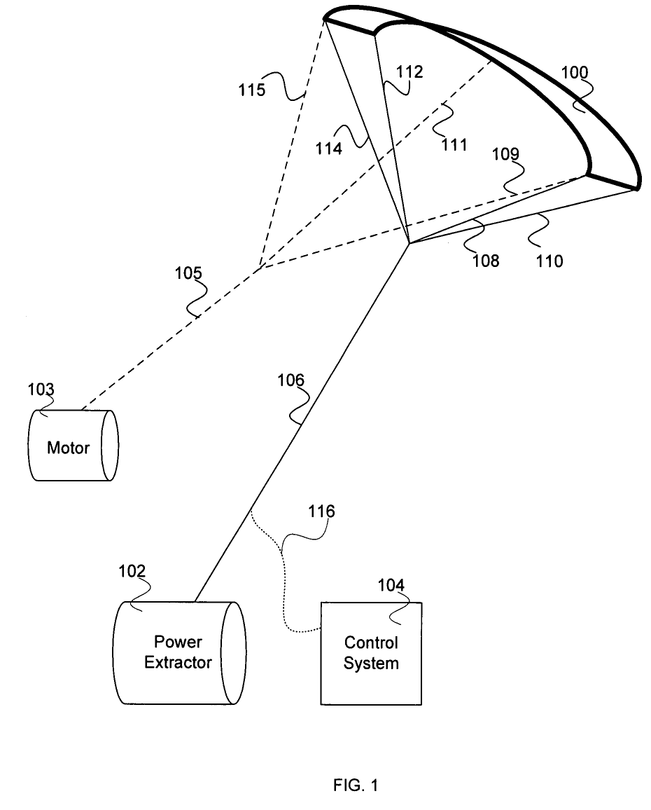

FIG. 1 is a block diagram illustrating an embodiment of a bimodal kite system. In the example shown, kite 100 is coupled to tether line 106 using bridal lines 108, 110, 112, and 114. In some embodiments, bridal lines 108, 110, 112, and 114 are control elements used to control kite 100 (e.g., when in a first tether-force configuration). For example, steering can be achieved by wing warping, or by adjusting the relative lengths of the bridal lines with respect to each other. In various embodiments, the line lengths can be adjusted using remotely operated motors and/or spindles. In various embodiments, control elements include control flaps, propellers, and/or kite shape changes that are used to control kite 100.

Tether line 106 is coupled to power extractor 102. Power extractor 102 extracts power from tethered line 106 as tethered line 106 is pulled by the wind acts on kite 100. In some embodiments, power extractor is an electric generator. In various embodiments, power extractor extracts power using an intermediate step or steps, or using any other appropriate manner of enabling power extraction. For example, power is extracted by first compressing air, pumping water, and then using the compressed air or pumped water to generated power. Control system 104 uses control elements—for example, lines 116—to control kite 100. In some embodiments, lines 116 comprise one or more physical lines that are mechanically coupled to kite 100 and used to control kite 100. In some embodiments, lines 116 comprise one or more signaling lines that are coupled to kite 100 and are used to control kite 100 by signaling to remote motors, switched, or other electrical devices that enable controlling kite 100. In some embodiments, lines 116 are not used to control kite 100, and, instead, a wireless system such a radio transmitter and receiver system are used to control kite 100. In various embodiments, control elements for kite 100 include flaps, control surfaces, propellers, motors, lines, spools, tails, retractable elements, switches, optical or electric signaling devices, lines, or any other appropriate element that can be used to control kite 100.

Kite 100 is coupled to tether line 105 using bridal lines 109, 111, and 115. In some embodiments, bridal lines 109, 110, and 115 are control elements that control system 104 uses to control kite 100 (e.g., when in a second tether-force configuration). For example, steering can be achieved by wing warping, or by adjusting the relative lengths of the bridal lines with respect to each other. In various embodiments, the line lengths can be adjusted using remotely operated motors and/or spindles. In various embodiments, control elements include control flaps, propellers, and/or kite shape changes that are used to control kite 100. Tether line 105 is coupled to motor 103 that can be used to recover or deploy kite 100.

In some embodiments, one or more physical lines (e.g., lines 116 or corresponding lines coupled to tether line 105) that are mechanically coupled to kite 100 and used to control kite 100 when using tether 105 (e.g., when in a second tether-force configuration). In some embodiments, one or more signaling lines (e.g., lines 116 or corresponding lines coupled to tether line 105) that are coupled to kite 100 and are used to control kite 100 by signaling to remote motors, switched, or other electrical devices that enable controlling kite 100. In some embodiments, a wireless system such a radio transmitter and receiver system are used to control kite 100 when in a second tether-force configuration.

In various embodiments, kite 100 comprises a bow kite, a ram air kite, a leading edge inflatable kite, a foil kite, a Rogallo wing kite, a power kite, a triangular-shaped wing kite, a tethered wing, a tethered kite, or any other appropriate kite for use as a configurable power generating kite.

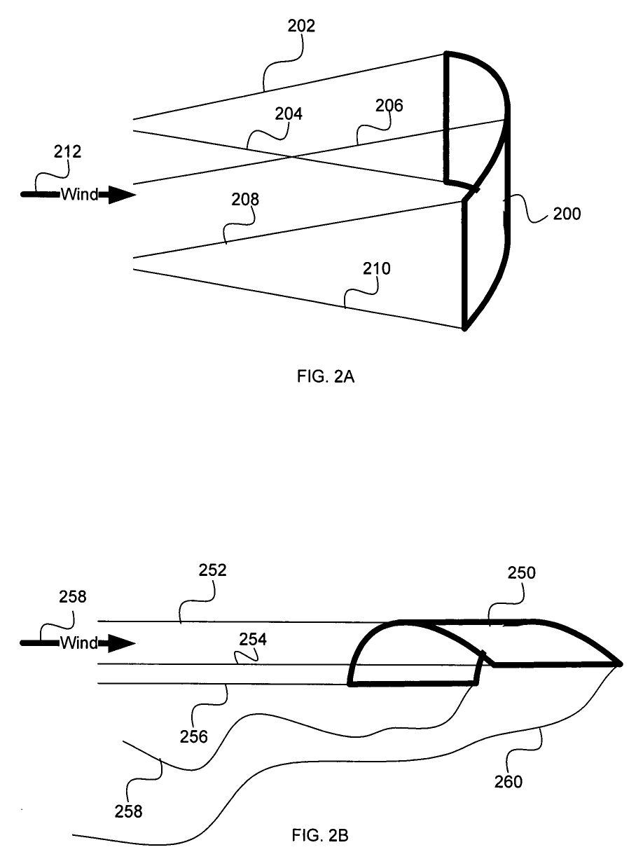

FIGS. 2A and 2B are block diagrams illustrating embodiments of bimodal kites. In the example shown in FIG. 2A, kite 200 is coupled to bridal lines 202, 204, 206, 208, and 210. In the configuration shown, wind blowing as indicated by arrow 212 is captured by kite 200 causing a force to be exerted on bridal lines 202, 204, 206, 208, and 210. Bridal lines 202, 204, 206, 208, and 210 are used as a control element of a control system to control kite 200 and also are coupled to a tether line which in turn is coupled to a power extractor. The power extractor is able to extract power from the wind blowing on kite 200.

In some embodiments, one or more motors or winches are used to change the bridal line lengths such that bridal line 202 is shorter than bridal line 204, bridal line 208 is shorter than bridal line 210, and bridal line 206 is made shorter similar to bridal lines 202 and 208 so that kite 200 switches between a first tether-force configuration and a second tether-force configuration. In some embodiments, the one or more motors or winches are controlled using a control system.

In the example shown in FIG. 2B, kite 250 is coupled to bridal lines 252, 254, and 256. In the configuration shown, wind blowing as indicated by arrow 258 is not significantly captured by kite 250 causing a relatively weak force (as compared to when kite 250 is in a configuration as shown by kite 200 in FIG. 2A) to be exerted on bridal lines 252, 254, and 256. Bridal lines 252, 254, and 256 are used as a control element of a control system to control kite 250 and are also coupled to a tether line which in turn is coupled to a power extractor. The power extractor is able to recover kite 250 by reeling in the tether line. The tether line force in the configuration shown in FIG. 2B is reduced as compared to the tether line force in the configuration shown in FIG. 2A. This improves the net power generated by the bimodal kite system.

In some embodiments, bridal line 256 of FIG. 2B and bridal line 202 of FIG. 2A are the same. In some embodiments, bridal line 256 of FIG. 2B includes bridal line 204 of FIG. 2A. In some embodiments, bridal line 254 of FIG. 2B and bridal line 208 of FIG. 2A are the same. In some embodiments, bridal line 254 of FIG. 2B includes bridal line 210 of FIG. 2A. In some embodiments, bridal line 252 of FIG. 2B and bridal line 206 of FIG. 2A are the same. In some embodiments, bridal lines can control kite 200 and/or kite 250 by changing their lengths (e.g., using a remote motor to wind a line on a spool, or shift line length from one bridal to another—from bridal line 208 to bridal line 210, etc.). In some embodiments, bridal line 206 and/or bridal line 252 are used to control a change in configuration from kite 200 to kite 250 or kite 250 to kite 200.

In some embodiments, bridal lines 258 and 260 (e.g., corresponding to bridal lines 204 and 210 of FIG. 2A) are coupled to kite 250 and are not involved in controlling kite 250 in the configuration shown in FIG. 2B.

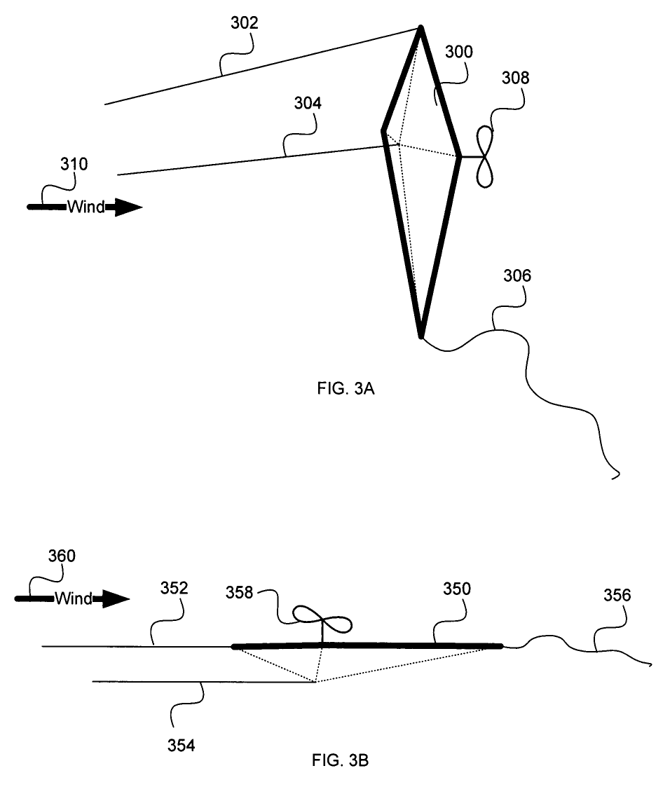

FIGS. 3A and 3B are block diagrams illustrating embodiments of bimodal kites. In the example shown in FIG. 3A, kite 300 is coupled to bridal lines 302 and 304. In the configuration shown, wind blowing as indicated by arrow 310 is captured by kite 300 causing a force to be exerted on bridal lines 302 and 304. Bridal lines 302 and 304 are coupled to a tether line which in turn is coupled to a power extractor. The power extractor is able to extract power from the wind blowing on kite 300. Kite 300 is controlled using tail 306 (e.g., retracting and deploying) and/or using propeller 308 (e.g., by creating more or less lift/drag at the point attached to propeller 308) as control elements of a control system.

In the example shown in FIG. 3B, kite 350 is coupled to bridal lines 352 and 354. In the configuration shown, wind blowing as indicated by arrow 360 is not significantly captured by kite 350 causing a relatively weak force (as compared to when kite 350 is in a configuration as shown by kite 300 in FIG. 3A) to be exerted on bridal lines 352 and 354. Kite 350 is controlled using propeller 358 and tail 356 as control elements of a control system. Bridal lines 352 and 354 are also coupled to a tether line which in turn is coupled to a power extractor. The power extractor is able to recover kite 350 by reeling in the tether line. The tether line force in the configuration shown in FIG. 3B is reduced as compared to the tether line force in the configuration shown in FIG. 3A. This enables a net power to be generated by the bimodal kite system.

In some embodiments, bridal line 352 of FIG. 3B and bridal line 302 of FIG. 3A are the same. In some embodiments, bridal line 354 of FIG. 3B and bridal line 304 of FIG. 3A are the same. In some embodiments, bridal lines can control kite 300 and/or kite 350 by changing their lengths (e.g., using a remote motor to wind a line on a spool) as control elements of a control system. For example, kite 300 can change its configuration to kite 350 or kite 350 can change its configuration to kite 300.

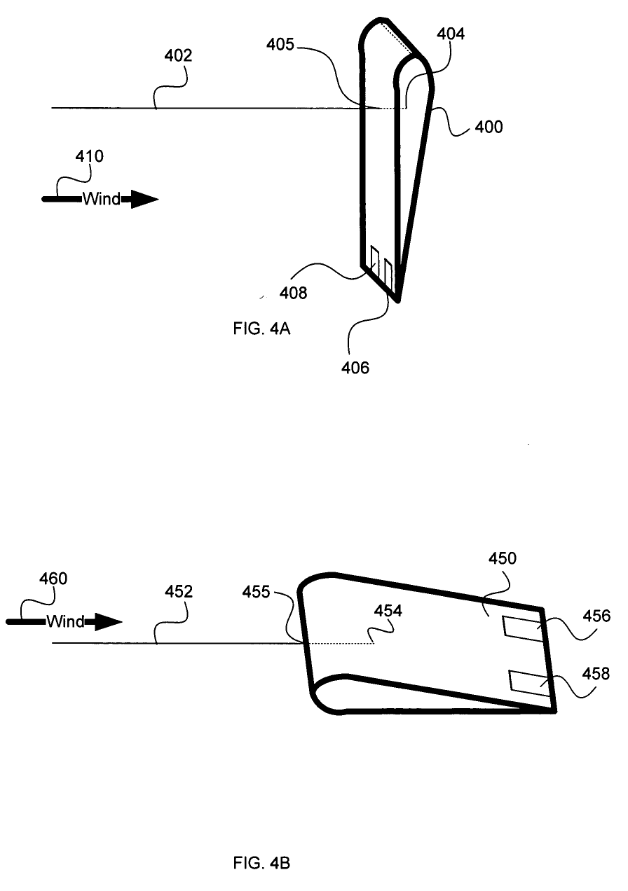

FIGS. 4A and 4B are block diagrams illustrating embodiments of bimodal kites. In the example shown in FIG. 4A, kite 400 is coupled to bridal line 402. In the configuration shown, wind blowing as indicated by arrow 410 is captured by kite 400 causing a force to be exerted on bridal line 402. Bridal line 402 is attached to kite 400 at 404 a ‘center of lift’ point of kite 400. The center of lift point is a point where the sum total of lift associated with kite 400 acts with no moments (e.g., rotating forces). Bridal line 402 is a tether line which is also coupled to a power extractor. The power extractor is able to extract power from the wind blowing on kite 400. Kite 400 is controlled using flaps 406 and 408, which are control elements of a control system.

In the example shown in FIG. 4B, kite 450 is coupled to bridal line 452. In the configuration shown, wind blowing as indicated by arrow 460 is not significantly captured by kite 450 causing a relatively weak force (as compared to when kite 450 is in a configuration as shown by kite 400 in FIG. 4A) to be exerted on bridal line 452. Kite 450 is controlled by control elements, flaps 458 and 456, that are part of a control system. Bridal line 452 is a tether line which is also coupled to a power extractor. The power extractor is able to recover kite 450 by reeling in the tether line. The tether line force in the configuration shown in FIG. 4B is less than the tether line force in the configuration shown in FIG. 4A. This improves the net power generated by the bimodal kite system.

In some embodiments, bridal line 452 of FIG. 4B and bridal line 402 of FIG. 4A are the same. In some embodiments, kite 400 and/or kite 450 can change its configuration using control elements such as the flaps (e.g., pivoting the flap above the kite surface or below the kite surface similar to an airplane wing flap). For example, kite 400 can change its configuration to kite 450 or kite 450 can change its configuration to kite 400.

In some embodiments, kite 400 and/or kite 450 can change its configuration using control elements such as an attachment point driver (e.g., a motorized attachment point that enables the attachment point at the kite to be moved on the surface for the kite). For example, for kite 400 in FIG. 4A the attachment point is driven to 405. Or for example, for kite 450 in FIG. 4B the attachment point is driven to 455.

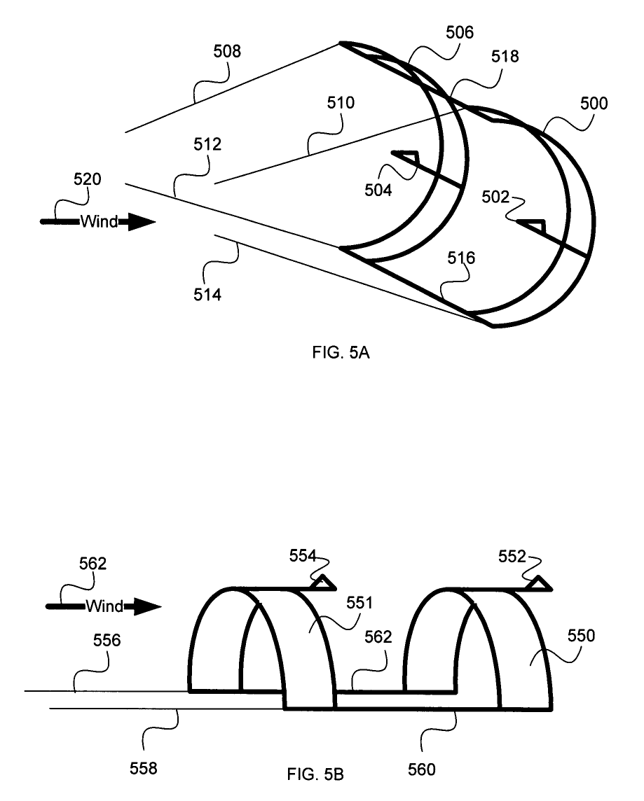

FIGS. 5A and 5B are block diagrams illustrating embodiments of bimodal kites. In the example shown in FIG. 5A, a half box/cylinder-type kite is comprised of two half cylinders 500 and 506 that are mechanically coupled together by rods 516 and 518. The kite is coupled to bridal lines 508, 510, 512, and 514. Tails 502 and 504 may be retractable and can be used as control elements of a control system to control the kite. In the configuration shown, wind blowing as indicated by arrow 520 is captured by the kite causing a force to be exerted on bridal lines 508, 510, 512, and 514. Bridal lines 508, 510, 512, and 514 are used to control the kite and also are coupled to a tether line which in turn is coupled to a power extractor. The power extractor is able to extract power from the wind blowing on the kite.

In the example shown in FIG. 5B, a kite comprised of two half cylinders 550 and 551 that are coupled together using rods 560 and 562. The kite is coupled to bridal lines 556 and 558. In the configuration shown, wind blowing as indicated by arrow 562 is not significantly captured by the kite causing a relatively weak force (as compared to when the kite in FIG. 5B is in a configuration as shown by the kite in FIG. 5A) to be exerted on bridal lines 556 and 558. Tails 552 and 554 can also be used to control the kite as a control element of a control system. Tails 552 and 554 can be retracted and deployed. In some embodiments, tails 552 and 554 have controlled flap surfaces in the vertical and horizontal planes (not shown in FIG. 5A or 5B) that enable more control of the kite. Bridal lines 556 and 558 are used to control the kite and are also coupled to a tether line which in turn is coupled to a power extractor. The power extractor is able to recover the kite by reeling in the tether line. The tether line force in the configuration shown in FIG. 5B is less than the tether line force in the configuration shown in FIG. 5A. This enables a net power to be generated by the bimodal kite system.

In some embodiments, bridal line 556 of FIG. 5B and bridal line 508 of FIG. 5A are the same. In some embodiments, bridal line 556 of FIG. 5B includes bridal line 510 of FIG. 5A. In some embodiments, bridal line 558 of FIG. 5B and bridal line 512 of FIG. 5A are the same. In some embodiments, bridal line 558 of FIG. 5B includes bridal line 514 of FIG. 5A. In some embodiments, bridal lines can control the kite of FIG. 5A and/or FIG. 5B by changing their lengths (e.g., using a remote motor to wind a line on a spool, or shift line length from one bridal to another—like bridal line 508 to bridal line 512, etc.). In some embodiments, relative bridal line lengths or tails are used to change configuration of the kite in FIG. 5A to the kite in FIG. 5B or vice versa.

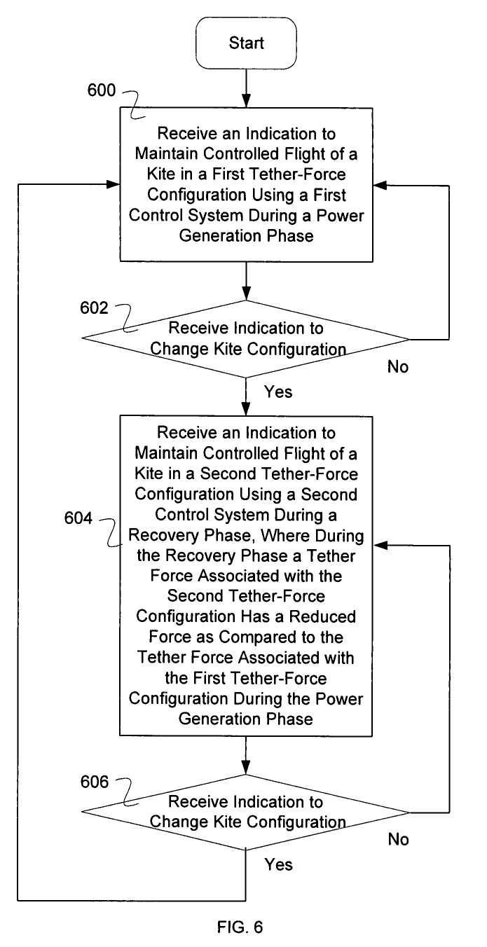

FIG. 6 is a flow diagram illustrating an embodiment of a process for controlling a kite. In the example shown, in 600 an indication is received to maintain controlled flight of a kite in a first tether-force configuration using a first control system during a power generating phase. In 602, it is determined if an indication is received to change kite configurations. If not, then control passes to 600. If so, then in 604 an indication is received to maintain controlled flight of a kite in a second tether-force configuration using a second control system during a recovery phase. During the recovery phase a tether force associated with the second tether-force configuration is reduced as compared to the tether force associated with the first tether-force configuration during the power generating phase enabling net power to be generated from the system. In 604, it is determined if an indication is received to change kite configurations. If not the control passes to 604. If so, then control passes to 600.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A kite comprising:
a first control element coupled to the kite in a first tether-force configuration, wherein the first control element is used to maintain controlled flight of the kite in the first tether-force configuration during a power generating phase; and
a second control element coupled to the kite in a second tether-force configuration, wherein the second control element is used to maintain controlled flight of the kite in the second tether-force configuration during a recovery phase, and wherein during the recovery phase a tether force associated with the second tether-force configuration is reduced as compared to the tether force associated with the first tether-force configuration during the power generating phase.

2. A kite as in claim 1, wherein the first control element and the second control element are combined.

3. A kite as in claim 1, wherein the first control element comprises a bridal line.

4. A kite as in claim 1, wherein the second control element comprises a bridal line.

5. A kite as in claim 1, wherein the first control element is coupled to the kite substantially at a center of lift point.

6. A kite as in claim 1, wherein the second control element is coupled to the kite substantially at a center of lift point.

7. A kite as in claim 1, wherein the kite comprises a half box-type kite.

8. A kite as in claim 1, wherein the kite comprises a bow kite.

9. A kite as in claim 1, wherein the kite comprises a leading edge inflatable kite.

10. A kite as in claim 1, wherein the kite comprises a foil kite.

11. A kite as in claim 1, wherein the kite comprises a Rogallo wing kite.

12. A kite as in claim 1, wherein the kite comprises a power kite.

13. A kite as in claim 1, wherein the kite comprises a triangular-shaped wing kite.

14. A kite as in claim 1, wherein the first control element includes a control line.

15. A kite as in claim 1, wherein the first control element includes a wireless signaling system.

16. A kite as in claim 1, wherein the first control element includes a tail.

17. A kite as in claim 16, wherein the tail can be deployed or retracted.

18. A kite as in claim 1, wherein the first control element includes a control surface on the kite.

19. A kite as in claim 18, wherein the control surface comprises a flap.

20. A kite as in claim 18, wherein the control surface comprises a spinning propeller.

21. A method for controlling a kite comprising:
receiving an indication to maintain controlled flight of a kite in a first tether-force configuration using a first control element during a power generation phase; and
in the event that an indication is received to change the kite to a second tether-force configuration, receiving an indication to maintain controlled flight of the kite in a second tethered-force configuration using a second control element during a recovery phase, wherein during the recovery phase a tether force associated with the second tether-force configuration is reduced as compared to the tether force associated with the first tether-force configuration during the power generating phase.

22. A computer program product for controlling a kite, the computer program product being embodied in a computer readable medium and comprising computer instructions for:
receiving an indication to maintain controlled flight of a kite in a first tether-force configuration using a first control element during a power generation phase; and
in the event that an indication is received to change the kite to a second tether-force configuration, receiving an indication to maintain controlled flight of the kite in a second tethered-force configuration using a second control element during a recovery phase, wherein during the recovery phase a tether force associated with the second tether-force configuration is reduced as compared to the tether force associated with the first tether-force configuration during the power generating phase.

23. A system for controlling a kite comprising:
a processor; and
a memory coupled with the processor, wherein the memory is configured to provide the processor with instructions which when executed cause the processor to:
receive an indication to maintain controlled flight of a kite in a first tether-force configuration using a first control element during a power generation phase; and
in the event that an indication is received to change the kite to a second tether-force configuration, receive an indication to maintain controlled flight of the kite in a second tethered-force configuration using a second control element during a recovery phase, wherein during the recovery phase a tether force associated with the second tether-force configuration is reduced as compared to the tether force associated with the first tether-force configuration during the power generating phase.
